(19) United States
(12) Patent Application Publication
(10) Pub. No.: US 2015/0328731 A1
(43) Pub. Date: Nov. 19, 2015

(54) REMOVING/CONNECTING STRUCTURE FOR COMPLEX MATERIAL OF THREADED ROD WORK PIECE AND WASHER

(71) Applicant: Chia Ching CHEN, Kaohsiung City (TW)

(72) Inventor: Chia Ching CHEN, Kaohsiung City (TW)

(21) Appl. No.: 14/279,271

(22) Filed: May 15, 2014

(51) Int. Cl. B23P 19/08

(52) U.S. Cl. CPC B23P 19/08

(57) ABSTRACT

A removing/connecting structure for complex material of threaded rod work piece and washer includes a machine body having abase seat and a rail vertically spaced from the base seat. The rail includes a front section and a rear section spaced from the front section. Each of the front and rear sections is composed of a first rail piece and a second rail piece mated with each other. A sensor unit is disposed between the root section of one of the first and second rail pieces and a main body. A cylinder is disposed under the rear section. A piston rod of the cylinder is disposed under the rear section. A bottom section of the rear section is connected with a fixing section of the cylinder, whereby the rear section is drivable by the piston rod to ascend/descend. The cylinder is connected to the sensor unit by means of signals.

### BACKGROUND OF THE INVENTION

1. Field of the Invention

The present invention relates generally to a complex material of threaded rod work piece and washer, and more particularly to a removing/connecting structure for the complex material of threaded rod work piece and washer.

2. Description of the Related Art

A conventional automatic screw/washer fitting/feeding apparatus includes a material guide structure and a material pushing structure. The material guide structure includes a fixing base seat, a guide board base seat and a spacer body, which are assembled to form a material guide channel. The material guide structure is connected with the material pushing structure to form a locating channel. The material guide channel receives the washer material to feed the washer material into the locating channel in which the washer material is located by an inclination. A press board is disposed at the upper end. The screw (not threaded yet, actually a threaded rod work piece) is fed and the press board applies a fixing force to the screw to push and downward press the inclined washer. At this time, a material guide body is pushed and moved. An arched body of the material guide body drives and pushes the washer upward. The washer moves along the slope of the inclined material guide body from an inclined position to a horizontal position. In this case, the threaded rod can be smoothly fitted into the central through hole of the washer and then go along material guide rail to the next manufacturing process. At this time, the automatic fitting process of the washer is completed.

However, after the automatic fitting process of the washer is completed, the successive process is still performed in the material guide rail. It often takes place that the size of the threaded rod work piece is different from the size of the washer to lead to material clog. Even if the size of the threaded rod work piece is the same as the size of the washer, material clog may still take place due to slight tilting. In case of material clog, the machine will be unable to normally function to affect the successive manufacturing process. Under such circumstance, it is necessary to stop the machine to remove the clogging material. This wastes time and leads to increase of manufacturing cost.

### SUMMARY OF THE INVENTION

It is therefore a primary object of the present invention to provide a removing/connecting structure for complex material of threaded rod work piece and washer to overcome the problem of the conventional device. The removing/connecting structure for complex material of threaded rod work piece and washer includes a machine body having a base seat and a rail. The rail is vertically spaced from the base seat by a distance. The rail includes a front section and a rear section spaced from the front section. Each of the front and rear sections is composed of a first rail piece and a second rail piece mated with each other to define a rail gap. A root section of at least one of the first and second rail pieces of the front section is pivotally connected with a main body by means of a pivot pin. An elastic member is disposed between the root section and the main body, whereby the rail piece can be elastically opened/closed, whereby a free end of one of the first and second rail pieces can be elastically operated and swung toward the base seat or away from the base seat around the pivot pin. A sensor unit is disposed between the root section of one of the first and second rail pieces and the main body. A cylinder is disposed under the rear section. A piston rod of the cylinder is disposed under the rear section. A bottom section of the rear section is connected with a fixing section of the cylinder, whereby the rear section is drivable by the piston rod to ascend/descend. The cylinder is connected to the sensor unit by means of signals. According to the above arrangement, the problem of washer material clog can be solved and the threaded rod work piece can further advance without interrupting the manufacturing process.

The present invention can be best understood through the following description and accompanying drawings, wherein:

### BRIEF DESCRIPTION OF THE DRAWINGS

FIG. 1 is a perspective view of the present invention in cooperation with the material feeding rail;

FIG. 2 is a perspective view of the present invention in cooperation with the material feeding rail, seen from another angle;

FIG. 3 is a perspective partially exploded view of the present invention in cooperation with the material feeding rail, seen from another angle;

FIG. 4 is a perspective view showing the operation of the second rail piece of the front section of the present invention in one state;

FIG. 5 is a perspective view showing the operation of the second rail piece of the front section of the present invention in another state;

FIG. 6 is a plane view showing the operation of the second rail piece of the present invention in one state; and

FIG. 7 is a plane view showing the operation of the second rail piece of the present invention in another state.

### DETAILED DESCRIPTION OF THE PREFERRED EMBODIMENTS

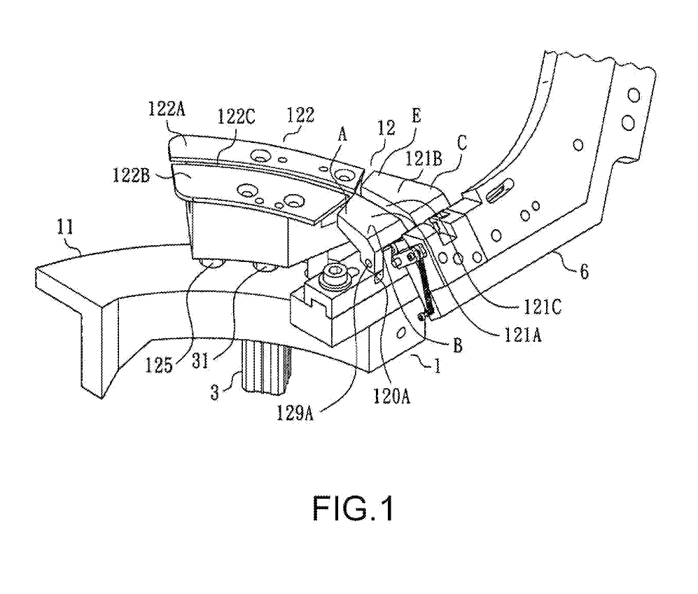

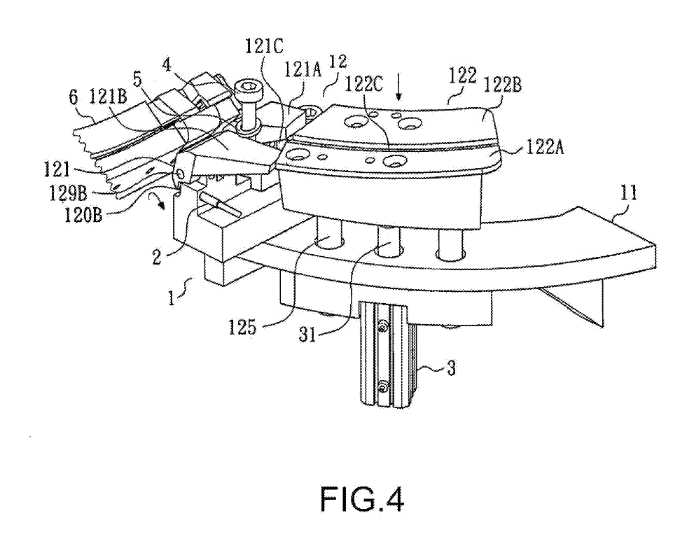

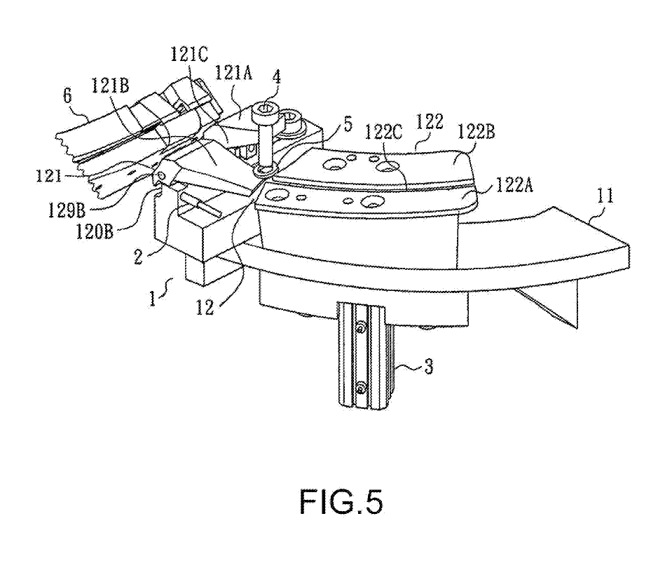

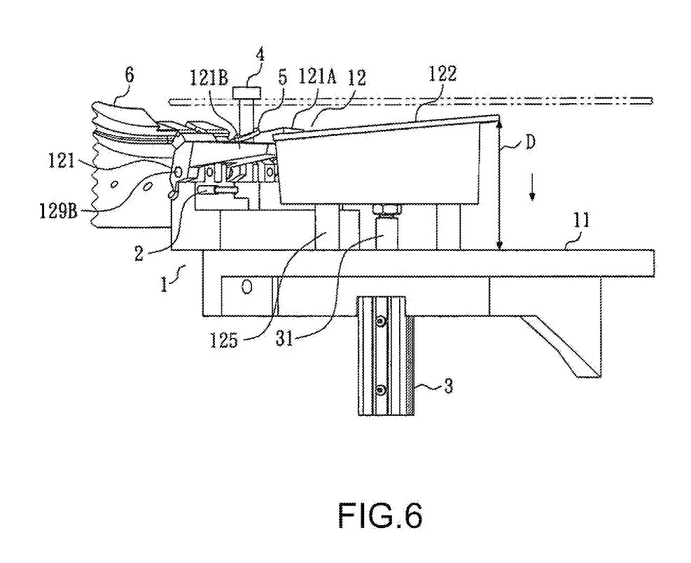

The present invention is related to a removing/connecting structure for complex material of threaded rod work piece and washer. Please refer to FIGS. 4 and 5. The machine of the present invention is able to extend a threaded rod work piece 4 into the hole of a washer 5. The threaded rod work piece 4 is first extended into the hole of the washer 5 and then threaded. Please refer to FIG. 1 together with FIG. 6. The present invention includes a machine body 1 having a base seat 11 and a rail 12. The rail 12 is vertically spaced from the base seat 11 by a distance D.

The rail 12 includes a front section 121 and a rear section 122 spaced from the front section 121. The front section 121 is composed of a first rail piece 121A and a second rail piece 121B mated with each other to define a rail gap 121C. The rear section 122 is composed of a first rail piece 122A and a second rail piece 122B mated with each other to define a rail gap 122C.

The first rail piece 121A of the front section 121 has a root section B pivotally connected with a main body 120A of the machine body 1 by means of a pivot pin 129A. An elastic member 127A is disposed between the root section B of the first rail piece 121A and the main body 120A, whereby the first rail piece 121A can be elastically opened/closed. Accordingly, a free end A of the first rail piece 121A can be elastically operated and swung toward the base seat 11 or away from the base seat 11 around the pivot pin 129A.

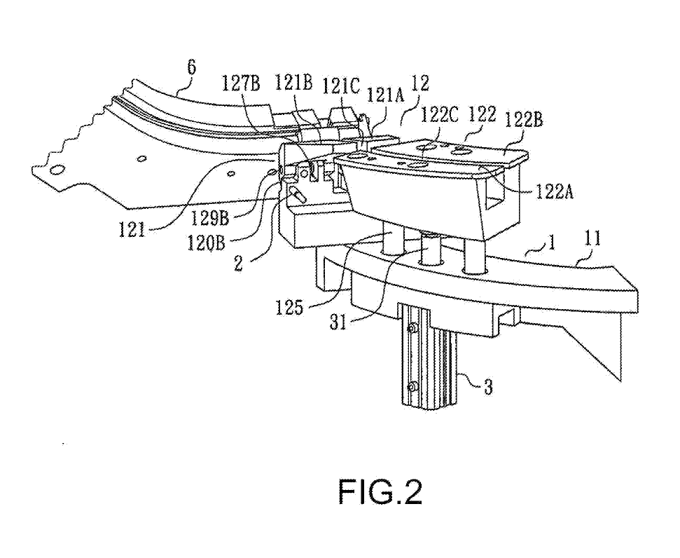

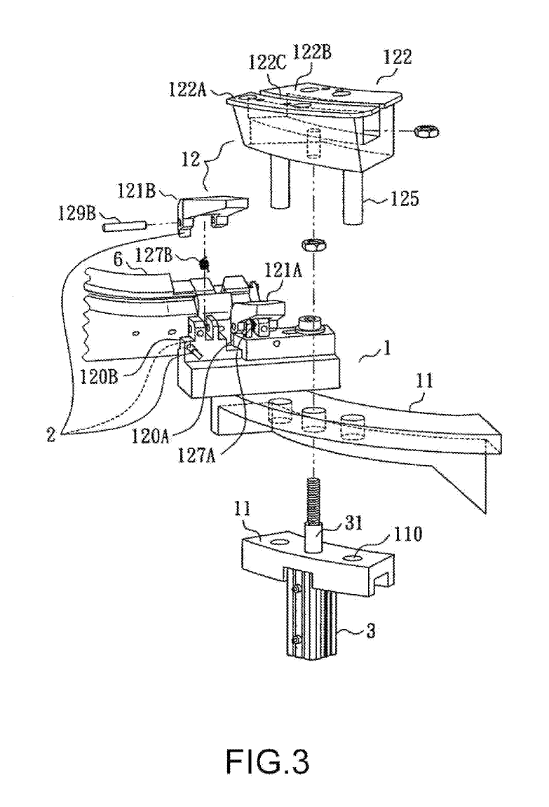

Please refer to FIG. 2 together with FIGS. 3 and 5. In the case that the size of the threaded rod work piece 4 is different from the size of the washer 5 or the threaded rod work piece 4 is slightly tilted to cause material clog, the free end A of the first rail piece 121A can be elastically operated and swung toward the base seat 11 or away from the base seat 11 around the pivot pin 129A. Accordingly, the gap between the first rail piece 121A and the second rail piece 121B can be adjusted and enlarged to easily remove the material.

Please refer to FIG. 2 together with FIG. 1. In a preferred embodiment, the second rail piece 121B of the front section 121 has a root section C pivotally connected with a main body 120B of the machine body 1 by means of a pivot pin 129B. An elastic member 127B is disposed between the root section C of the second rail piece 121B and the main body 120B, whereby the second rail piece 121B can be elastically opened/closed. Accordingly, a free end E of the second rail piece 121B can be elastically operated and swung toward the base seat 11 or away from the base seat 11 around the pivot pin 129B.

A sensor unit is disposed between the root section of one of the first and second rail pieces 121A, 121B and the main body.

In this embodiment, as shown in FIGS. 1 and 3, a sensor unit 2 is disposed between the root section C of the second rail piece 121B and the main body 120B. In addition, a cylinder 3 is disposed under the rear section 122. A piston rod 31 of the cylinder 3 is disposed under the rear section 122. A bottom section of the rear section 122 is connected with a fixing section of the cylinder 3, whereby the rear section 122 is drivable by the piston rod 31 to ascend/descend. The cylinder 3 is connected to the sensor unit 2 by means of signals. The signals can be wired signals or wireless signals.

Please refer to FIG. 1. The threaded rod work piece 4 is guided from a material guide rail 6 into the front section 121. When the threaded rod work piece 4 is tilted within the hole of the washer 5 to cause material clog, the free end E of the second rail piece 121B is forcedly pressed down. In the case that the washer 5 is not fitted onto the threaded rod work piece 4, the gap between the second rail piece 121B and the first rail piece 121A is enlarged to discharge the material.

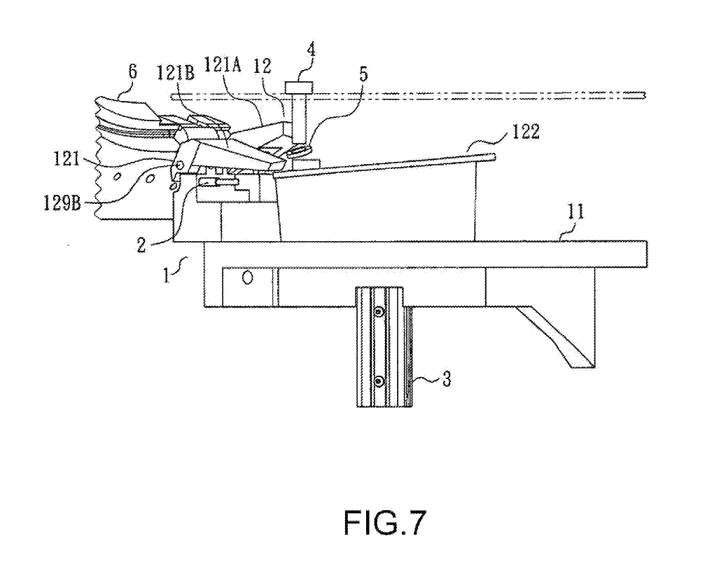

Please refer to FIG. 5 together with FIG. 7. In the case that the washer 5 is barely fitted on the threaded rod work piece 4 but not successfully fitted on the threaded rod work piece 4, the free end E of the second rail piece 121B will be forcedly pressed down due to slight clog. The sensor unit 2 is disposed between the root section C of the second rail piece 121B and the main body 120B. Therefore, when the sensor unit 2 detects that the contact state is changed, the sensor unit 2 will transmit a signal to the cylinder 3 to lower the cylinder 3. At this time, the rear section 122 is lowered along with the cylinder 3 to connect with the free end E of the second rail piece 121B.

Please refer to FIGS. 4 and 6. When the material is continuously advanced without clog, the free end E of the second rail piece 121B will bound back, whereby the root section C of the second rail piece 121B is restored into contact with the main body 120B. When the sensor unit 2 detects that the contact state is changed, the sensor unit 2 will transmit a signal to the cylinder 3 to lift the piston rod 31 of the cylinder 3. At this time, the rear section 122 is lifted along with the piston rod 31 of the cylinder 3 to connect with the free end E of the second rail piece 121B. Accordingly, the threaded rod work piece 4 and the washer 4 in which the threaded rod work piece 4 is extended are free from clog to further advance.

Please refer to FIG. 3. The cylinder 3 is disposed on the base seat 11. The base seat 11 is formed with two perforations 110. Two insertion pins 125 are disposed under the rear section 122 corresponding to the perforations 110. Accordingly, when the rear section 122 is driven by the piston rod 31, the rear section 122 can be stably lifted/lowered.

The above embodiments are only used to illustrate the present invention, not intended to limit the scope thereof. Many modifications of the above embodiments can be made without departing from the spirit of the present invention.

What is claimed is:

1. A removing/connecting structure for complex material of threaded rod work piece and washer, comprising a machine body having a base seat and a rail, the rail being vertically spaced from the base seat by a distance, the rail including a front section and a rear section spaced from the front section, each of the front and rear sections being composed of a first rail piece and a second rail piece mated with each other to define a rail gap, a root section of at least one of the first and second rail pieces of the front section being pivotally connected with a main body by means of a pivot pin, an elastic member being disposed between the root section and the main body, whereby the rail piece can be elastically opened/closed, whereby a free end of one of the first and second rail pieces can be elastically operated and swung toward the base seat or away from the base seat around the pivot pin, a sensor unit being disposed between the root section of one of the first and second rail pieces and the main body, a cylinder being disposed under the rear section, a piston rod of the cylinder being disposed under the rear section, a bottom section of the rear section being connected with a fixing section of the cylinder, whereby the rear section is drivable by the piston rod to ascend/descend, the cylinder being connected to the sensor unit by means of signals.

2. The removing/connecting structure for complex material of threaded rod work piece and washer as claimed in claim 1, wherein the cylinder is disposed on the base seat, the base seat being formed with two perforations, two insertion pins being disposed under the rear section corresponding to the perforations, whereby when the rear section is driven by the piston rod, the rear section can be stably lifted/lowered.
